(19) United States
(12) Patent Application Publication
(10) Pub. No.: US 2006/0179330 A1
(43) Pub. Date: Aug. 10, 2006

(54) Apparatus and method for ensuring power compatibility between a system board and a processing device

(76) Inventor: Gregory P. Ziarnik, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/045,833

(22) Filed: Jan. 27, 2005

(51) Int. Cl. G06F 1/26; G06F 1/30

(52) U.S. Cl. 713/300

(57) ABSTRACT

An i/o device on a system board has an input pin coupled via a resistor either to a logical high voltage in a first configuration or to a logical low voltage in a second configuration. The first and second configurations signify first and second power capabilities, respectively, of the system board. Before or during the boot process, a determination may be made whether a processing device installed on the system board is a high-power processing device, and a logic level of the input pin may be read. If a high-power processing device is present and the logic level of the input pin indicates the system board is not capable of supporting a high-power processing device, then the boot process may be stopped.

### FIELD OF THE INVENTION

This invention relates generally to computer system hardware and software, and more particularly to a technique for ensuring compatibility between system boards and processing devices such as central processing units (“CPUs”).

### BACKGROUND

System boards, also commonly called motherboards, are limited with respect to the amount of power they can supply to a processor such as a CPU. For example, desktop CPUs currently manufactured by Intel Corporation are divided into two classes—“mainstream” CPUs and “performance” CPUs. Some system boards are designed to source sufficient power to host either a performance CPU or a mainstream CPU, while other system boards are designed to support only a mainstream CPU. Operating a performance CPU in the latter type of system board can result in overheating, damage to components and possibly even fire. Consequently, it is necessary for system designers and manufacturers to ensure that each system board is matched appropriately with its processors.

The prior art solution to this problem has been for basic input/output services (“BIOS”) firmware to keep a hard-coded list of system board models that do not support high-power processors. During power-on selftest (“POST”), the BIOS would determine if a high-power processor is installed on the system board. If so, then the BIOS would determined the model number of the system board and would check the hard-coded list to determine whether the system board supports high-power processors. If not, the BIOS would disallow continuing with the boot procedure. This solution is somewhat undesirable in that the BIOS must keep a list of many different types of system boards. Moreover, whenever new system boards are released, the BIOS must be updated accordingly.

### BRIEF DESCRIPTION OF THE DRAWINGS

FIG. 1 is a block diagram illustrating circuitry according to a preferred embodiment of the invention for ensuring power compatibility between a system board and a processing device.

FIG. 2 is a flow diagram illustrating a method according to a preferred embodiment of the invention for ensuring power compatibility between a system board and a processing device.

### DETAILED DESCRIPTION OF THE PREFERRED EMBODIMENTS

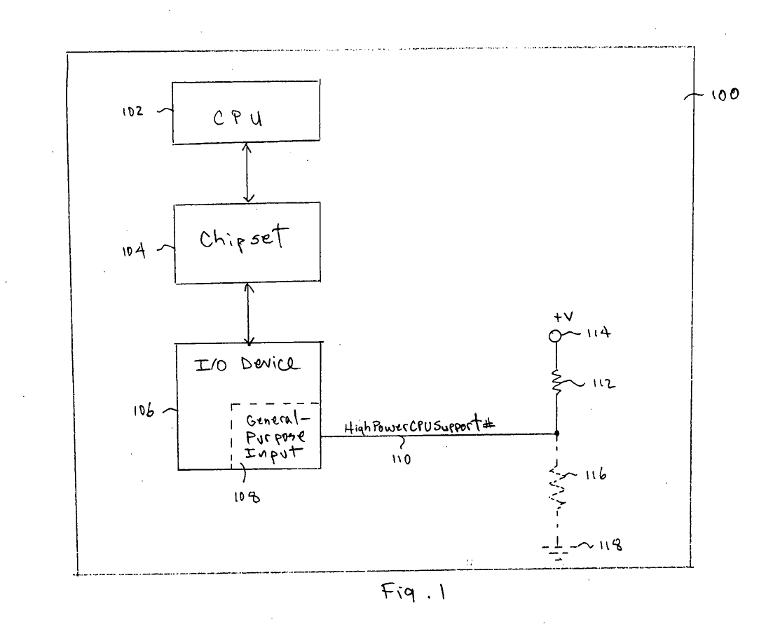

FIG. 1 illustrates a system board 100 according to a preferred embodiment of the invention. System board 100 may be, for example, a motherboard of a desktop or other type of computer system. System board 100 is configured (for example via a socket, direct solder or other conventional mounting arrangement) to receive one or more processing devices or modules 102. Processing devices or modules 102 may include any type of processing device such as a CPU. Once installed on system board 100, processing device 102 is coupled by a bus to a chipset 104. Chipset 104 may comprise one or more chips for providing interfaces to various other components of the computer system such as main memory, one or more hard disks, a network adapter, a graphics system, a sound system and numerous input/output (“i/o”) systems such as PCI systems, USB systems and the like. An i/o device 106 is coupled to chipset 104 by another bus as shown. I/o device 106 may be any of a variety of conventional devices capable of supporting a binary input signal. In one configuration, a binary input 108 on i/o device 106 is coupled via a resistor 112 to a logical high voltage 114 such as a supply voltage. In an alternative configuration, input 108 is instead coupled via a resistor 116 to a logical low voltage 118 such as a ground. These two configurations may be used to indicate whether or not system board 100 is capable of hosting a high-power processing device.

For the purposes of this document, “high-power” may be taken to mean any power consumption level higher than a threshold power consumption level. For example, in the case of the Intel Corporation CPUs described above, a performance processor could be classified as a high-power processor while a mainstream processor could be classified as a non-high-power processor.

In the illustrated embodiment, input 108 is an asserted-low signal. In such an embodiment, the configuration in which the signal is pulled up to a logical high voltage 114 would indicate that system board 100 is not capable of supporting a high-power processing device, while the configuration in which the signal is pulled down to a logical low voltage 118 would indicate that system board 100 is capable of supporting a high-power processor. In alternative embodiments, input 108 may be an asserted-high signal. In such alternative embodiments, the meanings of the two just-described configurations would be reversed.

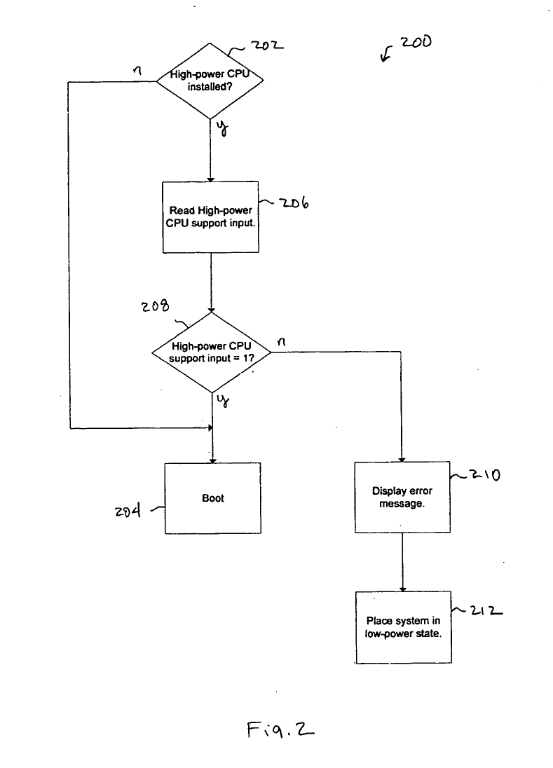

FIG. 2 illustrates a method 200 according to a preferred embodiment of the invention for ensuring compatibility between a system board such as system board 100 and one or more processing devices such as processing device 102. At any time before or during the boot process, a determination is made (step 202) whether a processing device installed on the system board is a high-power processing device. This determination may be made by any of a variety of techniques. In the case of CPUs currently manufactured by Intel Corporation, a preferred technique would be to read a machine-specific register in the processor to determine whether the processor is a mainstream or a performance CPU. If it is determined in step 202 that a high-power processing device is not installed, then the boot process may continue as indicated in step 204. But if a high-power processing device is present, then the logic level of input 108 may be read. If the logic level read on input 108 indicates that system board 100 is not capable of hosting a high-power processing device, then the boot process may be stopped. Stopping the boot process optionally may include displaying an error message as shown in step 210 and/or placing the system board in a lower-power-consumption state for safety. The low-power-consumption state could be simply the power-off state or any of a variety of conventional sleep states. Method 200 may be implemented by any programmatic means including, for example, in the BIOS firmware of the host computer system.

While the invention has been described in detail with reference to preferred embodiments thereof, the described embodiments have been presented by way of example and not by way of limitation. It will be understood by those skilled in the art that various changes may be made in the form and details of the described embodiments without deviating from the spirit and scope of the invention as defined by the appended claims. For example, the order of steps in method 200 may be altered without deviating from the scope of the invention as described and claimed. Input 108 may be read before any determination is made about the power requirements of the processing device. If the logic level of input 108 indicates that the system board is capable of supporting a high-power processor, then it would not be necessary to determine which type of processor is installed. But if the logic level of input 108 indicates that the system board is not capable of supporting a high-power processing device, then the determination of step 202 may be performed and the appropriate action taken depending on the outcome.

What is claimed is:

1. Apparatus for ensuring power compatibility between a system board and a processing device, comprising:
a system board configured to receive a processing device;
a chipset configured to be coupled to the processing device via a first bus; and
an i/o device coupled to the chipset via a second bus, the i/o device having an input pin that is coupled via a resistor either to a logical high voltage in a first configuration or to a logical low voltage in a second configuration, the first and second configurations signifying first and second power capabilities, respectively, of the system board.

2. The apparatus of claim 1:
wherein the system board is a computer motherboard.

3. The apparatus of claim 1:
wherein the processing device is a CPU.

4. The apparatus of claim 1:
wherein the first configuration signifies that the system board is capable of hosting a high-power processing device and the second configuration signifies that the system board is not capable of hosting a high-power processing device.

5. The apparatus of claim 1:
wherein the second configuration signifies that the system board is capable of hosting a high-power processing device and the first configuration signifies that the system board is not capable of hosting a high-power processing device.

6. A method for ensuring power compatibility between a system board and a processing device, comprising:
before or during a boot process:
determining whether a processing device installed on the system board is a high-power processing device;
reading a logic level of a single input signal, the logic level of the single input signal indicating whether the system board is capable of supporting a high-power processing device; and
if a high-power processing device is installed on the system board and the logic level of the single input signal indicates that the system board is not capable of supporting a high-power processing device, stopping the boot process.

7. The method of claim 6:
wherein stopping the boot process comprises displaying an error message.

8. The method of claim 6:
wherein stopping the boot process comprises placing the system board in a low-power-consumption state.

9. The method of claim 8:
wherein the low-power-consumption state is off.

10. The method of claim 6, wherein:
a logical high voltage on the single input signal indicates that the system board is capable of supporting a high-power processing device and a logical low voltage on the single input signal indicates that the system board is not capable of supporting a high-power processing device.

11. The method of claim 6, wherein:
a logical low voltage on the single input signal indicates that the system board is capable of supporting a high-power processing device and a logical high voltage on the single input signal indicates that the system board is not capable of supporting a high-power processing device.

12. The method of claim 6, wherein:
the processing device is a CPU.

13. Program code embodied in a storage or transmission medium that, when executed by a computer, causes the computer to perform a method for ensuring power compatibility between a system board and a processing device, the method comprising:
before or during a boot process:
determining whether a processing device installed on the system board is a high-power processing device;
reading a logic level of a single input signal, the logic level of the single input signal indicating whether the system board is capable of supporting a high-power processing device; and
if a high-power processing device is installed on the system board and the logic level of the single input signal indicates that the system board is not capable of supporting a high-power processing device, stopping the boot process.

14. The program code of claim 13:
wherein stopping the boot process comprises displaying an error message.

15. The program code of claim 13:
wherein stopping the boot process comprises placing the system board in a low-power-consumption state.

16. The program code of claim 15:
wherein the low-power-consumption state is off.
